(19) United States
(12) Patent Application Publication
(10) Pub. No.: US 2024/0243400 A1
(43) Pub. Date: Jul. 18, 2024

(54) METHOD FOR PRODUCING POWER STORAGE DEVICE

(71) Applicant: Prime Planet Energy & Solutions, Inc., Tokyo (JP)

(72) Inventor: Shingo YAMANE, Nagakute-shi (JP)

(21) Appl. No.: 18/496,928

(22) Filed: Oct. 30, 2023

(30) Foreign Application Priority Data
Jan. 18, 2023 (JP) 2023-005836

(51) Int. Cl. H01M 50/169; B23K 26/24; H01M 50/119

(52) U.S. Cl. CPC H01M 50/169; B23K 26/24; H01M 50/119; B23K 2101/36

(57) ABSTRACT

In a method for producing a power storage device including a circular recessed portion provided in a metal case, recessed inward in a thickness direction and formed with a liquid inlet port in an bottom portion, a recess surrounding portion around the circular recessed portion, and a cap part welded to the recess surrounding portion to hermetically seal the liquid inlet, the method includes setting at least an annular outer circumferential edge portion of an unwelded cap which will finally become the cap part in the circular recessed portion and bringing the outer circumferential edge portion into contact with an inner peripheral surface of the circular recessed portion over the entire circumference, and welding the outer circumferential edge portion to the recess surrounding portion over the entire circumference by an energy beam while holding the outer circumferential edge portion in contact with the inner peripheral surface over the entire circumference.

### CROSS-REFERENCE TO RELATED APPLICATIONS

This application is based upon and claims the benefit of priority to Japanese Patent Application No. 2023-005836 filed on Jan. 18, 2023, the entire contents of which are incorporated herein by reference.

### BACKGROUND

### Technical field

The present disclosure a method for producing a power storage device including a cap part that hermetically seals a liquid inlet of a metal case in which an electrode body and an electrolyte are housed.

### Related Art

For power storage devices, such as a lithium-ion secondary battery, including a metal case in which an electrode body and an electrolyte are housed, a power storage device in which a liquid inlet of a metal case is hermetically sealed with a cap part welded to the metal case and a producing method thereof have been conventionally known. One example of this technique is disclosed in WO 2009/128375A in which an unwelded cap is put over a liquid inlet of a lid of a case, which is a battery can, and then a peripheral edge portion of this cap is joined to the case. Specifically, the case (the lid) is provided with a cylindrical recess, which is one level lower than the outer surface of the case (the lid), and a liquid inlet is formed at the center of the bottom of the recess. In this recess, a cap with a disk-shaped outer circumference is inserted. The outer circumferential edge portion of the cap is welded by laser to the wall of the case surrounding the recess over the entire circumference.

### SUMMARY

### Technical Problems

However, to enable insertion of the outer circumferential edge portion of the cap into the cylindrical recess of the case, the outer dimension of the outer circumferential edge portion of the cap has to be smaller than the inner diameter of the recess. Therefore, when the outer circumferential edge portion of the cap is placed in the recess before welding, a gap is inevitably left between the inner peripheral surface of the recess of the case and an outer peripheral end face of the sealing cap. Moreover, the size of the gap is not always uniform over the entire circumference. In many cases, the outer peripheral end face of the cap is unevenly positioned with respect to the inner peripheral surface of the wall defining the recess of the case. In some cases, the cap may be placed with a part of the outer peripheral end face in the circumferential direction contacting with a part of the inner peripheral surface of the recess, thus leaving a large gap on the opposite side.

If the outer circumferential edge portion of the cap placed as above is laser-welded to the wall of the case over the entire circumference, the size of the gap varies, resulting in non-uniform welding conditions in the circumferential direction, which may lead to poor sealing and variations in sealing strength.

The present disclosure has been made to address the above problems and has a purpose to provide a method for producing a power storage device in which an outer peripheral end portion of a cap is welded uniformly over its entire circumference to a circular recessed portion provided in a metal case.

### Means of Solving the Problems

(1) To achieve the above-mentioned purpose, one aspect of the present disclosure provides a method for producing a power storage device that comprises an electrode body, an electrolyte, and a metal case accommodating the electrode body and the electrolyte, the metal case including: a circular recessed portion provided in a side wall constituting the metal case, the circular recessed portion being recessed toward an inside in a thickness direction of the side wall, the circular recessed portion being formed with a liquid inlet port in an annular bottom that forms a bottom surface of the circular recessed portion; a recess surrounding portion that surrounds the circular recessed portion; and a cap part welded to the recess surrounding portion to hermetically seal the liquid inlet port, wherein the method comprises: bringing an annular cap outer circumferential edge portion of an unwelded cap which will finally become the cap part, the cap outer circumferential edge portion being set in the circular recessed portion, into contact with an inner peripheral surface of the circular recessed portion of the metal case over an entire circumference (a contacting process); and welding the cap outer circumferential edge portion to the recess surrounding portion over an entire circumference by a laser beam, while holding the cap outer circumferential edge portion in contact with the inner peripheral surface of the circular recessed portion over the entire circumference (a full-circumference welding process).

In the above-described method, in the contacting process, at least the cap outer circumferential edge portion of the unwelded cap is set, or disposed, in the circular recessed portion provided in the metal case, and then the cap outer circumferential edge portion is brought into contact with the inner peripheral surface of the circular recessed portion. In this state, no gap is left between the inner peripheral surface of the circular recessed portion and the outer circumferential edge portion of the unwelded cap over the entire circumference. In a full-circumference welding process, thereafter, the cap outer circumferential edge portion is welded by an energy beam to the recess surrounding portion over the entire circumference while the cap outer circumferential edge portion is in contact with the inner peripheral surface of the circular recessed portion over the entire circumference. This method can therefore prevent variations in the size of the gap which result in non-uniform welding conditions in the circumferential direction, thus enabling uniform welding of the cap outer circumferential edge portion to the recess surrounding portion over the entire circumference, thus suppressing variations in sealing strength at the cap part.

The method for setting at least the cap outer circumferential edge portion of the unwelded cap in the circular recessed portion of the metal case, and then bringing the cap outer circumferential edge portion into contact with the inner peripheral surface of the circular recessed portion over the entire circumference may include the following methods. In one method, the cap outer circumferential edge portion of the unwelded cap, which can be radially expanded, is set in the circular recessed portion of the metal case, and then the diameter of the cap outer circumferential edge portion of the unwelded cap is expanded by a radially-expanding operation to bring the cap outer circumferential edge portion into contact with the inner peripheral surface of the circular recessed portion over the entire circumference. In another method, the diameter of the cap outer circumferential edge portion of the unwelded cap is contracted in advance by a radially-contracting operation, and the cap outer circumferential edge portion of the unwelded cap is set in the circular recessed portion of the metal case, and then the radially-contracting operation is released, allowing radial expansion of the cap outer circumferential edge portion of the unwelded cap to bring the cap outer circumferential edge portion into contact with the inner peripheral surface of the circular recessed portion over the entire circumference.

(2) The power storage device producing method described in (1), further comprises, after bringing the cap outer circumferential edge portion into contact with the inner peripheral surface of the circular recessed portion (the contacting process) but before welding the cap outer circumferential edge portion to the recess surrounding portion (the full-circumference welding process), temporarily fixing the cap outer circumferential edge portion to the circular recessed portion while holding the cap outer circumferential edge portion in contact with the inner peripheral surface of the circular recessed portion over the entire circumference (a temporarily fixing process).

This producing method includes the temporarily fixing process after the foregoing contacting process but before the full-circumference welding process. Therefore, after the temporarily fixing process, the full-circumference welding process can be performed while maintaining the contact state of the cap outer circumferential edge portion with the inner peripheral surface of the circular recessed portion over the entire circumference even without continuing the radially-expanding operation. This method can further prevent the unwelded cap from falling out of the circular recessed portion before the full-circumference welding process.

The method for temporarily fixing may be performed by welding the cap outer circumferential edge portion at several points in the circumference direction to the recess surrounding portion by an energy beam while holding the cap outer circumferential edge portion in contact with the inner peripheral surface of the circular recessed portion over the entire circumference. The temporarily fixing method may also be performed by sticking the cap outer circumferential edge portion to the annular bottom of the circular recessed portion with an adhesive material applied in advance to the cap outer circumferential edge portion, while holding the cap outer circumferential edge portion in contact with the inner peripheral surface of the circular recessed portion over the entire circumference.

(3) In the power storage device producing method described in (1) or (2), the unwelded cap is configured such that the cap outer circumferential edge portion is radially expanded by a radially-expanding operation, and bringing the cap outer circumferential edge portion into contact with the inner peripheral surface of the circular recessed portion (the contacting process) includes: placing the unwelded cap so that at least the cap outer circumferential edge portion of the unwelded cap is set in the circular recessed portion of the metal case (a placing process); and radially expanding the cap outer circumferential edge portion by the radially-expanding operation to bring the cap outer circumferential edge portion into contact with the inner peripheral surface of the circular recessed portion over the entire circumference (a radially-expanding and contacting process).

The aforementioned unwelded cap used in this producing method is an unwelded cap configured such that the cap outer circumferential edge portion can be expanded radially by the radially-expanding operation. In the contacting process, the unwelded cap whose diameter is not expanded yet is placed in the placing process, and then the cap outer circumferential edge portion is radially expanded to be brought into contact with the inner peripheral surface of the circular recessed portion over the entire circumference by the radially-expanding operation in the radially-expanding and contacting process. This method can therefore facilitate placing of the cap outer circumferential edge portion of the unwelded cap, which is not yet subjected to the radially-expanding operation, into the circular recessed portion.

The unwelded cap configured such that the cap outer circumferential edge portion can be radially expanded by the radially-expanding operation may include an unwelded cap made of a metal plate, which has a two-dimensional bell curved (i.e., two-dimensionally normal distribution curved) outer shape that is rotationally symmetrical about the cap axis, and the cap outer circumferential edge portion can be radially expanded by the radially-expanding operation performed by pressing the cap top portion at the center inward in the cap axis direction along the cap axis. Further, the unwelded cap may also include an unwelded cap including a circular disk-shaped cap central portion and a cap outer circumferential edge portion which surrounds the cap central portion and is smoothly flared out with the bottom trailed in the thickness direction. This the cap central portion is configured to selectively switch, when clicked, between a convex state spherically bulged toward a far side from the cap outer circumferential edge portion in the axis direction and a concave state spherically depressed toward a near side to the cap outer circumferential edge portion in the axis direction. This unwelded cap is configured to radially expand the cap outer circumferential edge portion when the cap central portion is switched to either one, the bulged state or the depressed state (i.e., the radially-expanding operation), whereas to radially contract the cap outer circumferential edge portion when the cap central portion is switched to the other state (i.e., the releasing operation or the radially-contracting operation).

(4) In the power storage device producing method described in (3), the unwelded cap is made of a metal plate and has a two-dimensional bell curved outer shape that is rotationally symmetric about a cap axis, the unwelded cap includes: a cap top portion; and the cap outer circumferential edge portion located on an outside relative to the cap top portion in a cap radial direction, and the radially-expanding operation is performed by: pressing the cap top portion inward in a cap axis direction from the cap top portion toward the cap outer circumferential edge portion; and radially expanding the cap outer circumferential edge portion outward in the cap radial direction.

In this producing method, the aforementioned unwelded cap has a two-dimensional bell curved outer shape that is rotationally symmetrical about the cap axis, including the cap top portion and the cap outer circumferential edge portion. The radially-expanding operation is to expand the cap outer circumferential edge portion outward in the cap radial direction by pressing the cap top portion inward in the cap axis direction. Accordingly, the placing process is performed by placing the unwelded cap so that the cap outer circumferential edge portion is set in the circular recessed portion of the metal case and then the radially-expanding and contacting process is performed by pressing the cap top portion of the unwelded cap inward in the cap axis direction, thus easily expanding the cap outer circumferential edge portion, i.e., increasing the diameter thereof, to bring the cap outer circumferential edge portion into contact with the inner peripheral surface of the circular recessed portion the entire circumference.

(5) In the power storage device producing method described in (1) or (2), the unwelded cap is configured such that the cap outer circumferential edge portion is radially elastically contracted by a radially-contracting operation, and bringing the cap outer circumferential edge portion into contact the inner peripheral surface of the circular recessed portion (the contacting process) includes: radially elastically contracting the cap outer circumferential edge portion by the radially-contracting operation (a radially-contracting process); placing the unwelded cap so that at least the radially contracted cap outer circumferential edge portion of the unwelded cap is set in the circular recessed portion (a placing process); and releasing the radially-contracting operation to radially expand the cap outer circumferential edge portion to bring the cap outer circumferential edge portion into contact with the inner peripheral surface of the circular recessed portion over the entire circumference (a releasing and contacting process).

The aforementioned unwelded cap used in this producing method is an unwelded cap configured such that the cap outer circumferential edge portion can be radially elastically contracted by the radially-contracting operation. In the contacting process, the unwelded cap that has been radially elastically contracted, i.e., reduced in diameter, is placed in the placing process, and then the radially-contracting operation is released, allowing the cap outer circumferential edge portion to radially expand into contact with the inner peripheral surface of the circular recessed portion over the entire circumference by the radially-expanding operation in the releasing and contacting process. Thus, in the full-circumference welding process or temporarily fixing process, which will be performed after the radially-contracting operation is released, welding can be reliably conducted without being interrupted by for example a jig for the radially-contracting operation.

The unwelded cap configured such that the cap outer circumferential edge portion can be elastically radially contracted by the radially-contracting operation may include an unwelded cap, which is made of a metal plate and has a two-dimensional bell curved outer shape rotationally symmetrical about the cap axis, and the cap outer circumferential edge portion can be elastically radially contracted by the radially-contracting operation performed by sucking the cap inner portion, located inside the cap outer circumferential edge portion corresponding to the bottom portion in the cap radial direction, toward a far side from the cap outer circumferential edge portion along the cap axis. Further, the unwelded cap may also include an unwelded cap configured such that the cap outer circumferential edge portion is expanded in diameter when the cap central portion is switched to either one, the convex state or the concave state, whereas the cap outer circumferential edge portion is contracted in diameter when the cap central portion is switched to the other state.

(6) In the power storage device producing method described in (5), the unwelded cap is made of a metal plate and has a two-dimensional bell curved outer shape that is rotationally symmetric about a cap axis, the unwelded cap includes: the cap outer circumferential edge portion; and a cap inner portion located on an inside relative to the cap outer circumferential edge portion in a cap radial direction perpendicular to an axis direction of the unwelded cap, and the radially-contracting operation is performed by: sucking the cap inner portion outward in the cap axis direction, from the cap outer circumferential edge portion toward the cap inner portion; and radially elastically contracting the cap outer circumferential edge portion inward in the cap radial direction.

In this producing method, the aforementioned unwelded cap has a two-dimensional bell curved outer shape rotationally symmetrical about the cap axis, including the cap outer circumferential edge portion and the cap inner portion. The radially-contracting operation is to suck the cap inner portion outward in the cap axis direction to elastically contract the cap outer circumferential edge portion inward in the cap radial direction. Accordingly, the radially-contracting and placing process is performed by placing the unwelded cap with the contracted diameter so that the cap outer circumferential edge portion is set in the circular recessed portion of the metal case and then the releasing and contacting process is performed by releasing the radially-contracting operation, that is, stopping suction, allowing the cap outer circumferential edge portion to radially expand to bring the cap outer circumferential edge portion into contact with the inner peripheral surface of the circular recessed portion the entire circumference.

(7) In the power storage device producing method described in one of (1) to (6), the inner peripheral surface of the circular recessed portion of the metal case has a shape whose diameter is larger toward the inside in the thickness direction of the side wall, and the unwelded cap includes a cap outer peripheral end face having a shape whose diameter is larger toward the inside in the thickness direction of the side wall when the cap outer circumferential edge portion of the unwelded cap is set in the circular recessed portion.

In this producing method, the inner peripheral surface of the circular recessed portion of the metal case and the cap outer circumferential edge portion of the unwelded cap are each shaped with the diameter larger toward the inside in the thickness direction (the thickness-direction inside). In the contacting process, therefore, when the cap outer circumferential edge portion of the unwelded cap is radially expanded to contact the inner peripheral surface of the circular recessed portion over the entire circumference, the unwelded cap engages with the circular recessed portion and thus is less likely to slip out. This method can therefore reliably prevent the unwelded cap from falling out of the circular recessed portion after the contacting process until the full-circumference welding process or temporarily fixing process.

### BRIEF DESCRIPTION OF THE DRAWINGS

FIG. 1 is a partially-broken vertical cross-sectional view of a battery in first and second embodiments and a modified embodiment;

FIG. 2 is a flowchart showing steps for producing the battery in the first embodiment and the modified embodiment;

FIG. 3 is an enlarged partial cross-sectional view showing that an unwelded cap is placed and welded to a circular recessed portion of a lid of the battery in the first and second embodiments and the modified embodiment;

FIG. 4 is an enlarged partial cross-sectional view showing that the unwelded cap is placed in the circular recessed portion of the lid of the battery in the first embodiment;

FIG. 5 is an enlarged partial cross-sectional view showing that the unwelded cap placed in the circular recessed portion of the lid of the battery is pressed to radially expand, bringing an outer circumferential edge portion into contact with an inner peripheral surface of the lid of the battery in the first embodiment;

FIG. 6 is an explanatory view showing that the outer circumferential edge portion of the unwelded cap is temporarily fixed to the circular recessed portion by laser welding while holding the outer circumferential edge portion in contact with the inner peripheral surface of the circular recessed portion over the entire circumference in the first embodiment;

FIG. 7 is an explanatory view showing the shape of the outer circumferential edge portion of the unwelded cap and the shape of the inner peripheral surface of the circular recessed portion of the lid in the modified embodiment;

FIG. 8 is a flowchart showing steps for producing a battery in the second embodiment;

FIG. 9 is an explanatory view showing a relationship in diameter between the circular recessed portion of the lid of the battery and the unwelded cap in the second embodiment;

FIG. 10 is an enlarged partial cross-sectional view showing that the unwelded cap is sucked and radially contracted in the second embodiment;

FIG. 11 is an enlarged partial cross-sectional view showing that the unwelded cap with the contracted diameter is set in the circular recessed portion of the lid of the battery in the second embodiment;

FIG. 12 is an enlarged partial cross-sectional view showing that the unwelded cap is released from suction and thus radially expanded, bringing the outer circumferential edge portion into contact with the inner peripheral surface of the circular recessed portion over the entire circumference in the second embodiment; and

FIG. 13 is an explanatory view showing that the outer circumferential edge portion is temporarily fixed to the circular recessed portion by laser welding while holding the outer circumferential edge portion of the unwelded cap in contact with the inner peripheral surface of the circular recessed portion over the entire circumference in the second embodiment.

### DETAILED DESCRIPTION OF THE EXEMPLARY EMBODIMENTS

### First Embodiment

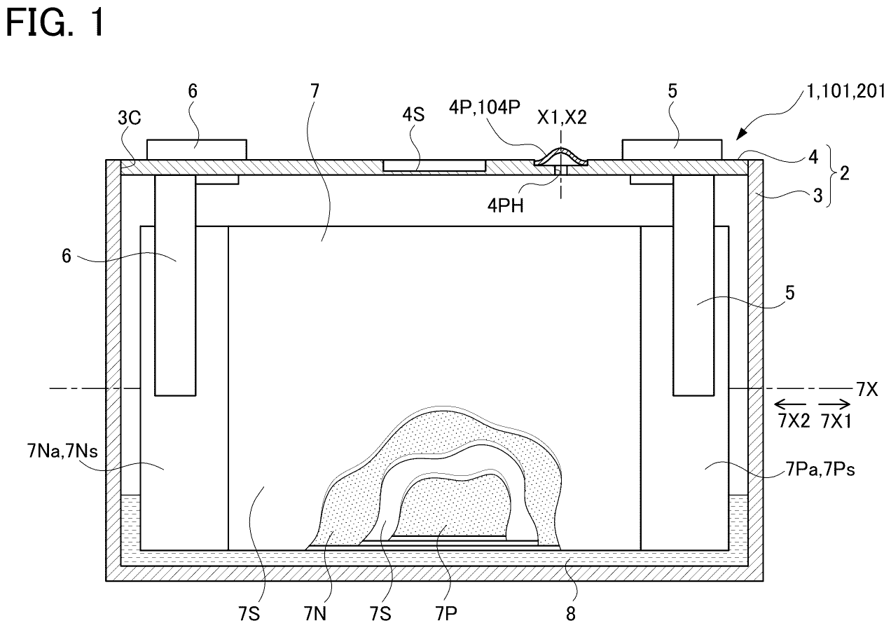

A detailed description of a first embodiment of a lithium-ion secondary battery (hereinafter, also simply referred to as a battery) 1 in a first embodiment of this disclosure will now be given referring to FIGS. 1 to 6. As shown in FIG. 1, the rectangular battery 1 to be produced in the first embodiment includes a flat wound electrode body (hereinafter, also simply referred to as an electrode body) 7, a case 2 made of metal (aluminum in the present embodiment) and formed in a rectangular parallelepiped box-shape housing therein the electrode body 7, a positive terminal 5 and a negative terminal 6 each supported by this case 2, and others. The case 2 contains an electrolyte 8, a part of which is impregnated in the electrode body 7 and the rest is accumulated on the bottom of the case 2.

The rectangular parallelepiped box-shaped case 2 includes a case body 3 having a bottomed rectangular tube shape with an opening 3C and a lid 4 having a rectangular plate shape welded to the case body 3 to close the opening 3C. This lid 4 is fixedly provided with the positive terminal 5 and the negative terminal 6 via insulating members not illustrated in FIG. 1. Further, the lid 4 is provided, at the center, with a non-recovery type safety valve 4S that is thinner than other portions of the lid 4 and can break open when the inner pressure of the case 2 exceeds a predetermined valve opening pressure to release the gas generated in the case 2 to the outside. In addition, the lid 4 includes, between the safety valve 4S and the positive terminal 5, a liquid inlet port 4PH penetrating through lid 4 in its thickness direction and a liquid inlet part 4P hermetically sealing the liquid inlet port 4PH. The hole axis X1 of the liquid inlet port 4PH coincides with the thickness direction of the lid 4.

The electrode body 7 is a flat wound electrode body in which a strip-shaped positive plate 7P and a strip-shaped negative plate 7N are wound together with two strip-shaped separators 7S alternately interposed. Each of the separators 7S is made of a porous resin film, and flattened in a flat shape. The electrode body 7 is enclosed in a bottomed rectangular tubular resin film (not illustrated) and arranged therein so that its winding axis 7X extends horizontally in the case 2. The electrode body 7 includes a positive current collecting part 7Ps which is an exposed part of a positive current collecting foil 7Pa of the wound positive electrode plate 7P on one side 7X1 (i.e., the right side in FIG. 1) in the winding axis direction. The positive terminal 5 is welded to this positive current collecting part 7Ps. Further, the electrode body 7 includes a negative current collecting part 7Ns which is an exposed part of a negative current collecting foil 7Na of the wound negative electrode plate 7N on the other side (i.e., the left side in FIG. 1) in the winding axis direction. The negative terminal 6 is welded to this negative current collecting part 7Ns.

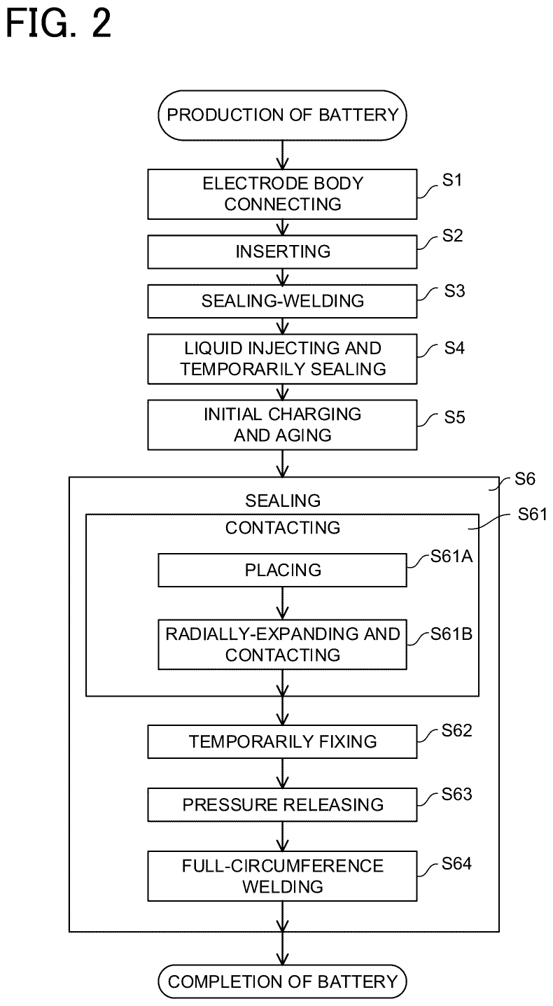

The producing procedure for the battery 1 will be described below, referring to a flowchart in FIG. 2. The flat wound electrode body 7 mentioned above is produced separately in a well-known method. Further, the positive terminal 5 and the negative terminal 6 are fixed to the lid 4 in advance. Then, in an electrode body connecting step S1, the positive terminal 5 is welded to the positive current collecting part 7Ps of the electrode body 7 and the negative terminal 6 is welded to the negative current collecting part 7Ns to integrate the lid 4, positive terminal 5, negative terminal 6, and electrode body 7 in one piece. In an inserting step S2, the electrode body 7 is enclosed in the resin film (not illustrated) folded in a bottomed rectangular tube shape, and these resin film and electrode body 7 are inserted in the case body 3 through the opening 3C and then the opening 3C is closed with the lid 4. In a sealing-welding step S3, the open end of the case body 3, defining the opening 3C, and the peripheral edge of the lid 4 are laser-welded over the entire circumference, sealing the opening 3C and integrating the case body 3 and the lid 4, eventually forming the case 2.

In a liquid injecting and temporarily sealing step S4, subsequently, the electrolyte 8 is injected into the case 2 through the liquid inlet port 4PH of the lid 4 and then this liquid inlet port 4PH is temporarily closed with a rubber plug (not illustrated). The injected electrolyte 8 is impregnated into the electrode body 7 and also accumulates on the bottom of the case 2. In an initial aging step S5, the battery 1 is subjected to initial charging in which a voltage is applied between the positive terminal 5 and the negative terminal 6, and then this battery 1 is left for a predetermined time under high-temperature environment.

In a sealing step S6, the rubber plug for temporary sealing is removed from the liquid inlet port 4PH, and an unwelded cap 14C mentioned later is welded to the the lid 4 around the liquid inlet port 4PH over the entire circumference, hermetically sealing the liquid inlet port 4PH. Thus, the battery 1 is completed.

The detailed sealing operation in the sealing step S6 to seal the liquid inlet port 4PH using the unwelded cap 14C is described below. Prior to this description of the sealing step S6, the following description will be given to the shape of the unwelded cap 14C, the shape of a part of the lid 4 of the case 2, around the liquid inlet port 4PH before welding of the unwelded cap 14C, and the shape of the liquid inlet part 4P after sealing.

As shown in FIG. 4, the lid 4, constituting one of six side walls of the rectangular parallelepiped case 2, has a lid outer surface 4OS facing outward, i.e., upward in FIGS. 1 and 4. The lid 4 further includes a circular recessed portion 4PR. Specifically, the circular recessed portion 4PR is configured to be cylindrically recessed from the lid outer surface 4OS toward the inside HXI in the hole axis direction, which will be referred to as the hole-axis-direction inside HXI. At the center of an annular bottom portion 4PS, which forms a bottom surface 4PRB of the circular recessed portion 4PR, the aforementioned liquid inlet port 4PH is formed penetrating through the lid 4. In the present embodiment, specifically, the circular recessed portion 4PR is concentric with the liquid inlet port 4PH and thus the center axis of the circular recessed portion 4PR coincides with the hole axis X1 of the liquid inlet port 4PH. In the lid 4, a portion surrounding the circular recessed portion 4PR is referred to as a recess surrounding portion 4PM. Further, the inner diameter of the circular recessed portion 4PR is referred as a recess inner diameter D4.

On the other hand, the unwelded cap 14C is made of a metal plate (e.g., aluminum in the present embodiment) and has a two-dimensional bell curved (i.e., normal distribution curved or bell curved) outer shape rotationally symmetric about the cap axis X2, as shown in FIG. 4. Specifically, the unwelded cap 14C generally has a three-dimensional shape depicted by rotating the bell curve (i.e., the normal distribution curve) a half about the cap axis X2 which is the central axis of the bell curve. This unwelded cap 14C includes a top portion 14CT located at the center and protruding toward the outside CXO in the cap axis direction (referred to as the cap-axis-direction outside CXO), i.e., upward in FIGS. 1 and 4, and an annular outer circumferential edge portion 14CP located on the outside CRO in the cap radial direction (referred to as the cap-radial-direction outside CRO) relative to the top portion 14CT and expanding, i.e., flaring, toward the cap-radial-direction outside CRO. The top portion 14CT is one example of a cap top portion of the present disclosure. The outer circumferential edge portion 14CP is one example of a cap outer circumferential edge portion of the present disclosure. The outer diameter of this unwelded cap 14C is referred to as a cap outer diameter 14D. As shown in FIG. 4, the cap outer diameter 14D of the unwelded cap 14C in a free, i.e., unrestricted, state is smaller than the recess inner diameter D4 of the circular recessed portion 4PR (14D<4D).

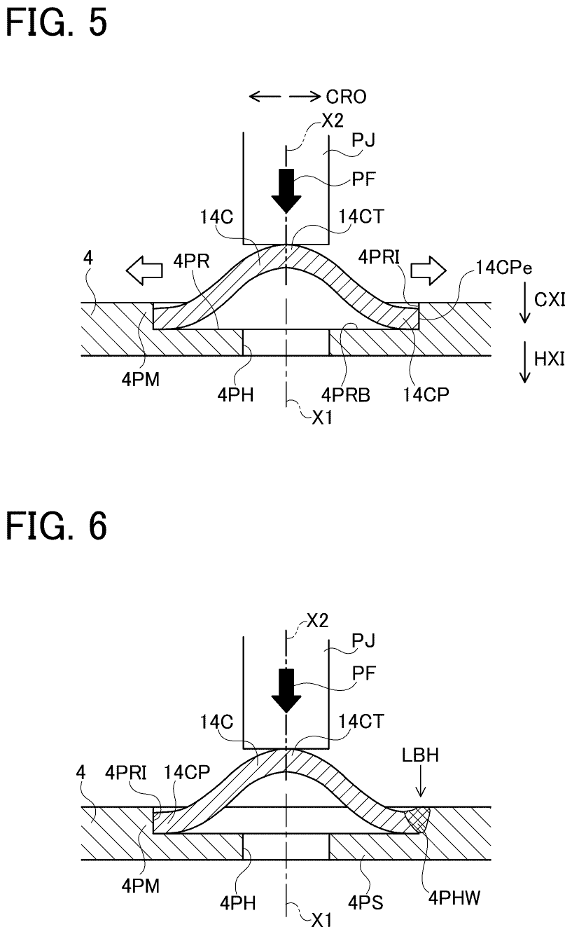

The unwelded cap 14C in the first embodiment is configured such that the outer circumferential edge portion 14CP can be radially expanded by a radially-expanding operation. For this unwelded cap 14C, the radially-expanding operation is an operation to expand the outer circumferential edge portion 14CP radially outward, that is, toward the cap-radial-direction outside CRO, by pressing the top portion 14CT inward, that is, toward the inside CXI in the cap axis direction (referred to as the cap-axis-direction inside CXI), i.e., downward in FIG. 5, from the top portion 14CT toward the outer circumferential edge portion 14CP along the cap axis X2.

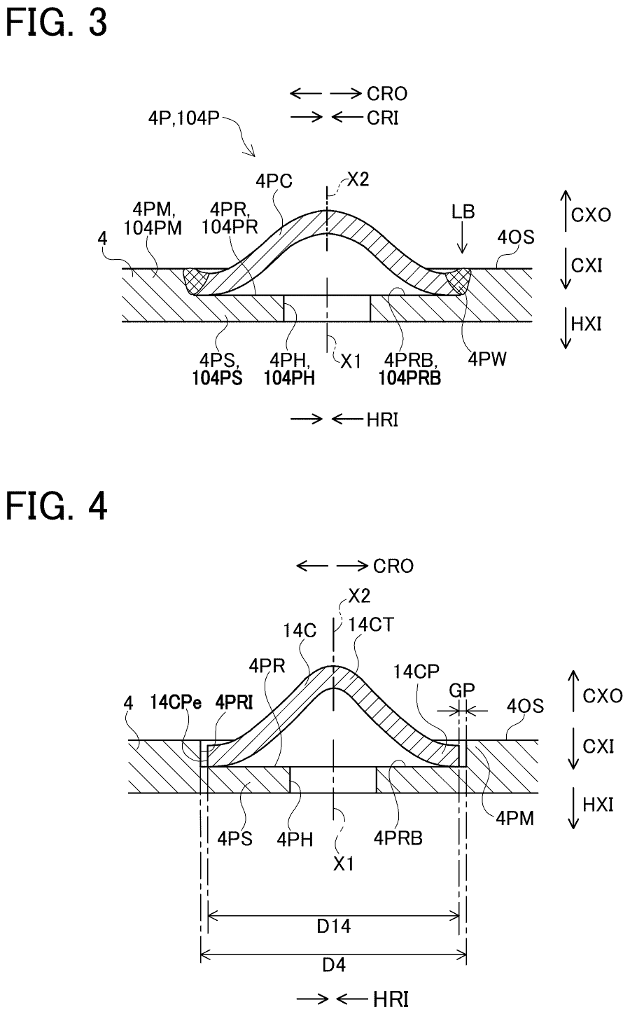

Therefore, the outer circumferential edge portion 14CP of the unwelded cap 14C is set, or disposed, in the circular recessed portion 4PR of the lid 4 first, and then the outer circumferential edge portion 14CP is radially expanded to bring the outer peripheral end face 14CPe of the unwelded cap 14C into contact with the inner peripheral surface 4PRI of the circular recessed portion 4PR over its entire circumference. In this state, the outer circumferential edge portion 14CP is then welded to the recess surrounding portion 4PM by a laser beam LB (one example of an energy beam) over the entire circumference, so that an annular melt-solidification part 4PW is formed. Thus, the liquid inlet part 4P is formed hermetically sealing the liquid inlet port 4PH (see FIGS. 1 and 3). This liquid inlet part 4P includes a cap part 4PC of a two-dimensional curved shape rotationally symmetrical about the cap axis X2, which is derived from the unwelded cap 14C and welded to the recess surrounding portion 4PM.

The sealing step S6 is described below. In the sealing step S6, a contacting step S61 is performed by bringing the outer circumferential edge portion 14CP of the unwelded cap 14C which will finally become the cap part 4PC, the outer circumferential edge portion 14CP being set, or disposed, in the circular recessed portion 4PR, into contact with the inner peripheral surface 4PRI of the circular recessed portion 4PR over the entire circumference.

Concretely, in a placing step S61A of the contacting step S61, the unwelded cap 14C is placed so that the outer circumferential edge portion 14CP of the unwelded cap 14C is set in the circular recessed portion 4PR, that is, the outer circumferential edge portion 14CP is in contact with the annular bottom portion 4PS over the entire circumference, as shown in FIG. 4. Since the cap outer diameter 14D of the unwelded cap 14C in the free state is smaller than the recess inner diameter D4 of the circular recessed portion 4PR (14D<4D), as described above, the outer circumferential edge portion 14CP can be easily set in the circular recessed portion 4PR. In this state, a gap GP occurs between the outer peripheral end face 14CPe of the unwelded cap 14C and the inner peripheral surface 4PRI of the circular recessed portion 4PR.

In a radially-expanding and contacting step S61B, the unwelded cap 14C is subjected to the radially-expanding operation to radially expand the outer circumferential edge portion 14CP, that is, to increase the outer diameter of the outer circumferential edge portion 14CP relative to the cap outer diameter 14D in the free state, thereby bringing the outer circumferential edge portion 14CP into contact with the inner peripheral surface 4PRI of the circular recessed portion 4PR over the entire circumference. In other words, the outer peripheral end face 14CPe of the unwelded cap 14C is made to contact the inner peripheral surface 4PRI of the circular recessed portion 4PR over the entire circumference. At that time, the unwelded cap 14C is moved and positionally adjusted so that the cap axis X2 is aligned with the hole axis X1 of the circular recessed portion 4PR and the liquid inlet port 4PH. That is, the unwelded cap 14C is automatically aligned with the circular recessed portion 4PR and the liquid inlet port 4PH.

As described above, the unwelded cap 14C can expand the outer circumferential edge portion 14CP radially outward, i.e., toward the cap-radial-direction outside CRO by the radially-expanding operation of pressing the top portion 14CT toward the cap-axis-direction inside CXI, i.e., downward in FIG. 5.

In the radially-expanding and contacting step S61B, therefore, as indicated by a black arrow in FIG. 5, the top portion 14CT of the unwelded cap 14C is pressed at the pressing force PF toward the cap-axis-direction inside CXI (downward in FIG. 5), radially expanding the outer circumferential edge portion 14CP toward the cap-radial-direction outside CRO as indicted by white arrows, so that the outer circumferential edge portion 14CP contacts the inner peripheral surface 4PRI of the circular recessed portion 4PR over the entire circumference. To be specific, a press rod PJ is used to press the top portion 14CT toward the cap-axis-direction inside CXI.

In a temporarily fixing step S62, prior to a full-circumference welding step S64, while the pressing force PF continues to be applied as indicated by a black arrow in FIG. 6, the outer circumferential edge portion 14CP of the unwelded cap 14C is welded to the recess surrounding portion 4PM at the appropriate number of scattered points. In the first embodiment, using a laser beam LBH for temporary fixing, the outer circumferential edge portion 14CP and the recess surrounding portion 4PM are laser-welded together at three scattered points spaced at an angle of approximate 120° in the circumferential direction. Thus, the outer circumferential edge portion 14CP is temporarily fixed to the recess surrounding portion 4PM through three temporarily-joined portions 4PHW, while maintaining a contact state with the inner peripheral surface 4PRI of the circular recessed portion 4PR over the entire circumference. Consequently, even without maintaining the radially-expanding operation and others, that is, even if the pressing force PF is released, the full-circumference welding step S64 can be performed as described later while retaining the outer circumferential edge portion 14CP in contact with the inner peripheral surface 4PRI of the circular recessed portion 4PR over the entire circumference. This can further prevent the unwelded cap 14C from falling out of the circular recessed portion 4PR of the lid 4.

In the pressure releasing step S63, therefore, the pressing force PF indicated by the black arrow in FIG. 6 is released. Specifically, the press rod PJ is removed.

In the full-circumference welding step S64, furthermore, while the outer circumferential edge portion 14CP is in contact with the inner peripheral surface 4PRI of the circular recessed portion 4PR over the entire circumference, the outer circumferential edge portion 14CP is welded to the recess surrounding portion 4PM by the laser beam LB throughout the circumference. Thus, the liquid inlet port 4PH is hermetically sealed with the cap part 4PC (see FIG. 3). Moreover, the cap part 4PC in the first embodiment can prevent circumferential variations in welding conditions due to variations in the size of the gap GP, enabling uniform welding of the outer circumferential edge portion 14CP to the recess surrounding portion 4PM over the entire circumference, thus suppressing variations in the sealing strength of the cap part 4PC.

### Modified Embodiment

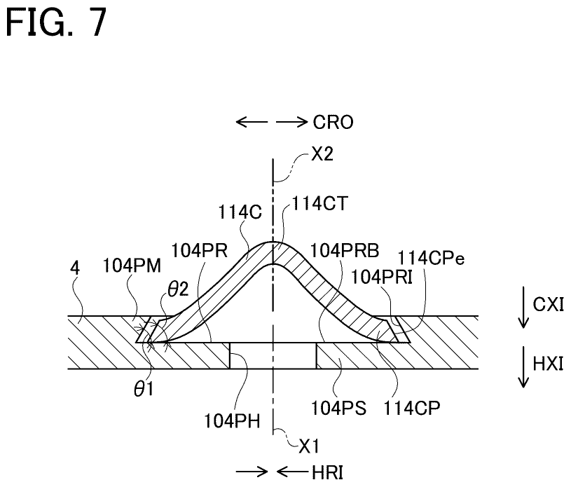

A method for producing a battery 101 provided with a liquid inlet port 104PH in a modified embodiment, which is a variation of the first embodiment, will be described below referring to FIG. 7. This method for producing the battery 101 in this modified embodiment is similar to the first embodiment excepting the shape of an inner peripheral surface 104PRI of a circular recessed portion 104PR of a lid 4 used in the sealing step S6 and the shape of an outer peripheral end face 114CPe of an unwelded cap 114C. Therefore, the following description is given with a focus on differences from the first embodiment and similar or identical parts to those in the first embodiment are assigned the same reference signs as those in the first embodiment and their details are omitted or simplified.

The circular recessed portion 104PR of the lid 4, which is formed with the liquid inlet port 104PH at the center, used in this modified embodiment is configured such that the inner peripheral surface 104PRI has a truncated conical face shape whose diameter is larger toward the inside HXI in the hole axis direction (referred to as the hole-axis-direction inside HXI), i.e., downward in FIG. 7, that is, toward a bottom surface 104PRB of an annular bottom portion 104PS, as easily understood from FIG. 7.

On the other hand, the outer peripheral end face 114CPe of the unwelded cap 114C has a shape whose diameter is larger toward the cap-axis-direction inside CXI, i.e., downward in FIG. 7. Thus, the outer peripheral end face 114CPe has a truncated conical face shape whose diameter is larger toward the hole-axis-direction inside HXI while the outer circumferential edge portion 114CP of the unwelded cap 114C is set in the circular recessed portion 104PR.

In the foregoing contacting step S61, concretely, in the radially-expanding and contacting step S61B, when the top portion 114CT of the unwelded cap 114C is pressed toward the cap-axis-direction inside CXI, radially expanding the outer circumferential edge portion 114CP, bringing the outer circumferential edge portion 114CP into contact with the inner peripheral surface 104PRI of the circular recessed portion 104PR over the entire circumference, the unwelded cap 114C engages with the circular recessed portion 104PR and hence is less likely to slip out. This can reliably prevent the unwelded cap 114C from falling out of the circular recessed portion 104PR after the contacting step S61 until the temporarily fixing step S62.

The first angle θ1 between the bottom surface 104PRB and the inner peripheral surface 104PRI of the circular recessed portion 104PR and the second angle θ2 between the bottom surface 104PRB of the circular recessed portion 104PR and the outer peripheral end face 114CPe of the unwelded cap 114C may be set to 60° to 85°. Further, the second angle θ2 may be set larger than the first angle θ1 (θ1<θ2). This is because this expanding operation generates a force that presses the outer circumferential edge portion 114CP of the unwelded cap 114C against the annular bottom portion 104PS, so that the unwelded cap 114C can be placed stably in the circular recessed portion 104PR.

### Second Embodiment

A method for producing a battery 201 in a second embodiment will be described below, referring to FIGS. 1, 2, and 8 to 13. The foregoing first embodiment exemplifies the method for producing the battery 1, in which the unwelded cap 14C capable of radially expanding the outer circumferential edge portion 14CP by the radially-expanding operation of pressing the top portion 14CT is welded to the circular recessed portion 4PR of the lid 4.

In contrast, the method for producing the battery 201 in the second embodiment is different from the first embodiment in using an unwelded cap 214C configured such that an outer circumferential edge portion 214CP can be radially elastically contracted by a radially-contracting operation of sucking an inner portion 214CI including a top portion 214CT. Thus, the following description is given with a focus on differences from the first embodiment and similar or identical parts to those in the first embodiment are assigned the same reference signs as those in the first embodiment, and their details are omitted or simplified.

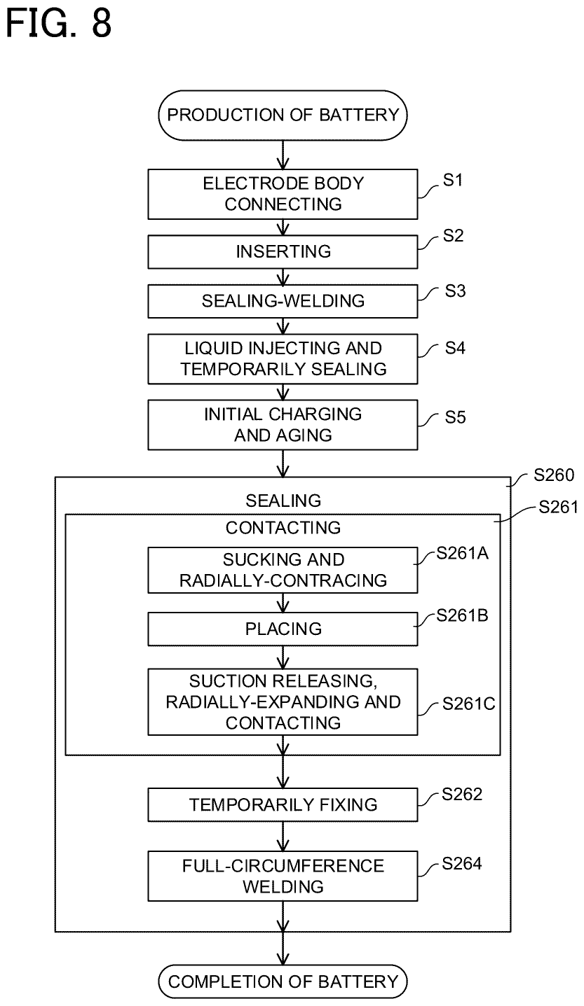

The configuration of the battery 201 in the second embodiment and the electrode body connecting step S1 through the initial charging and aging step S5 in the producing method are identical to those in the first embodiment (see FIG. 3) and their details are omitted. In contrast, a sealing step S260, different from the sealing step S6 in the first embodiment, will be described below (see FIG. 8).

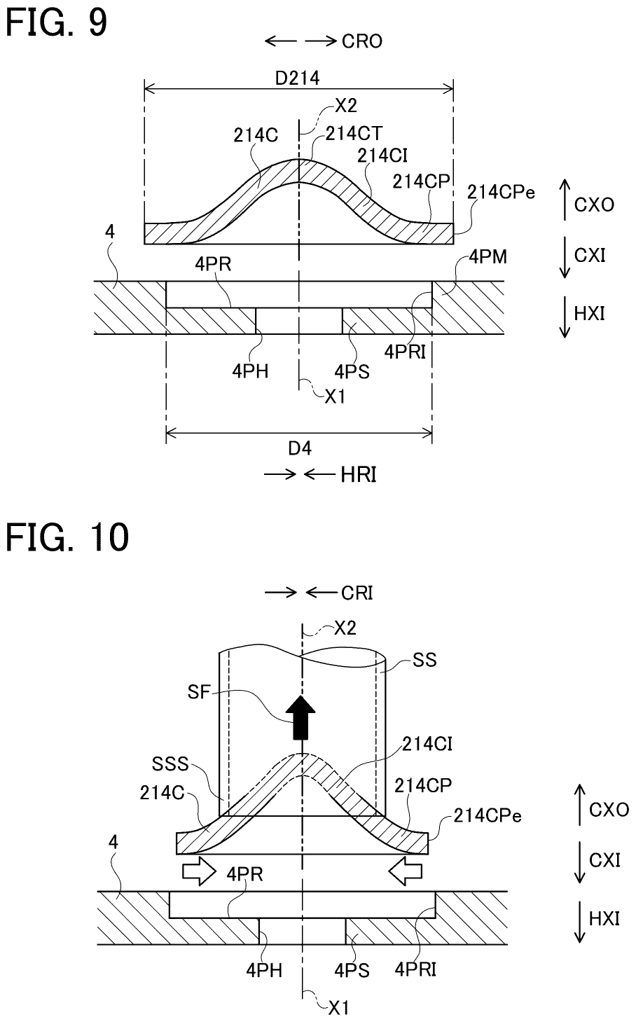

As shown in FIG. 9, the unwelded cap 214C is also made of a metal plate (e.g., aluminum in the second embodiment) and has a two-dimensional bell curved (i.e., normal distribution curved or bell curved) outer shape rotationally symmetric about the cap axis X2. Specifically, the unwelded cap 214C also generally has a three-dimensional shape depicted by rotating the bell curve (i.e., the normal distribution curve) a half about the cap axis X2 which is the central axis of the bell curve. This unwelded cap 214C also includes a top portion 214CT located at the center and protruding toward the cap-axis-direction outside CXO, i.e., upward in FIGS. 1 and 9, and an annular outer circumferential edge portion 214CP located on the cap-radial-direction outside CRO relative to the top portion 214CT and expanding, i.e., flaring, toward the cap-radial-direction outside CRO. The top portion 214CT is one example of the cap top portion of the present disclosure. The outer circumferential edge portion 214CP is one example of the cap outer circumferential edge portion of the present disclosure. A part of the unwelded cap 214C, located on the cap-radial-direction inside CRI more than the outer circumferential edge portion 214CP is referred to as an inner portion 214CI, which is one example of a can inner portion of the present disclosure. The outer diameter of this unwelded cap 214C is referred to as a can outer diameter 214D. As shown in FIG. 9, the cap outer diameter 214D of the unwelded cap 214C in a free, i.e., unrestricted, state is larger than the recess inner diameter D4 of the circular recessed portion 4PR (214D>4D).

The unwelded cap 214C in the second embodiment is configured such that the outer circumferential edge portion 214CP can be radially elastically contracted by the radially-contracting operation. For this unwelded cap 214C, the radially-contracting operation is an operation to elastically contract the outer circumferential edge portion 214CP radially inward, that is, toward the cap-radial-direction inside CRI, by elastically sucking the inner portion 214CI toward the cap-axis-direction outside CXO, i.e., upward in FIG. 9, from the outer circumferential edge portion 214CP toward the top portion 214CT.

Therefore, the outer circumferential edge portion 214CP of the unwelded cap 214C radially contracted in advance is set in the circular recessed portion 4PR of the lid 4. Further, the outer circumferential edge portion 214CP is released from the radially contracted state and thus elastically radially expanded, bringing an outer peripheral end face 214CPe of the unwelded cap 214C into contact with the inner peripheral surface 4PRI of the circular recessed portion 4PR over the entire circumference. In addition, as in the first embodiment, the outer circumferential edge portion 214CP is then welded to the recess surrounding portion 4PM by the laser beam LB over the entire circumference, so that the annular melt-solidification part 4PW is formed. Thus, the liquid inlet part 4P is formed hermetically sealing the liquid inlet port 4PH (see FIGS. 1 and 3). This liquid inlet part 4P in the second embodiment, as in the first embodiment, includes the cap part 4PC of a two-dimensional curved shape rotationally symmetrical about the cap axis X2, which is derived from the unwelded cap 214C and welded to the recess surrounding portion 4PM.

The sealing step S260 is described below. In the sealing step S260, a contacting step S261 is performed by bringing the outer circumferential edge portion 214CP of the unwelded cap 214C which will finally become the cap part 4PC, the outer circumferential edge portion 214CP being set, or disposed, in the circular recessed portion 4PR, into contact with the inner peripheral surface 4PRI of the circular recessed portion 4PR over the entire circumference.

Concretely, in a sucking and radially-contracting step S261A of the contacting step S261, a suction pipe SS is placed in position so that its distal end portion SSS contacts the inner portion 214CI of the unwelded cap 214C and the top portion 214CT is inserted in the distal end portion SSS, as shown in FIG. 10. A vacuum pump not illustrated is connected to the suction pipe SS and exhaust air from the suction pipe SS to generate a sucking force SF indicated by a black arrow in FIG. 10, causing the distal end portion SSS of the suction pipe SS to suck the inner portion 214CI of the unwelded cap 214C. This suction deforms the inner portion 214CI of the unwelded cap 214C so as to become narrow, thus elastically contracting the outer circumferential edge portion 214CP radially toward the cap-radial-direction inside CRI as indicated by white arrows so that the cap outer diameter 214Ds of the outer circumferential edge portion 214CP in the contracted state is smaller than the outer diameter 214D in the free state and further smaller than the recess inner diameter D4 of the circular recessed portion 4PR (214Ds<4D<214D).

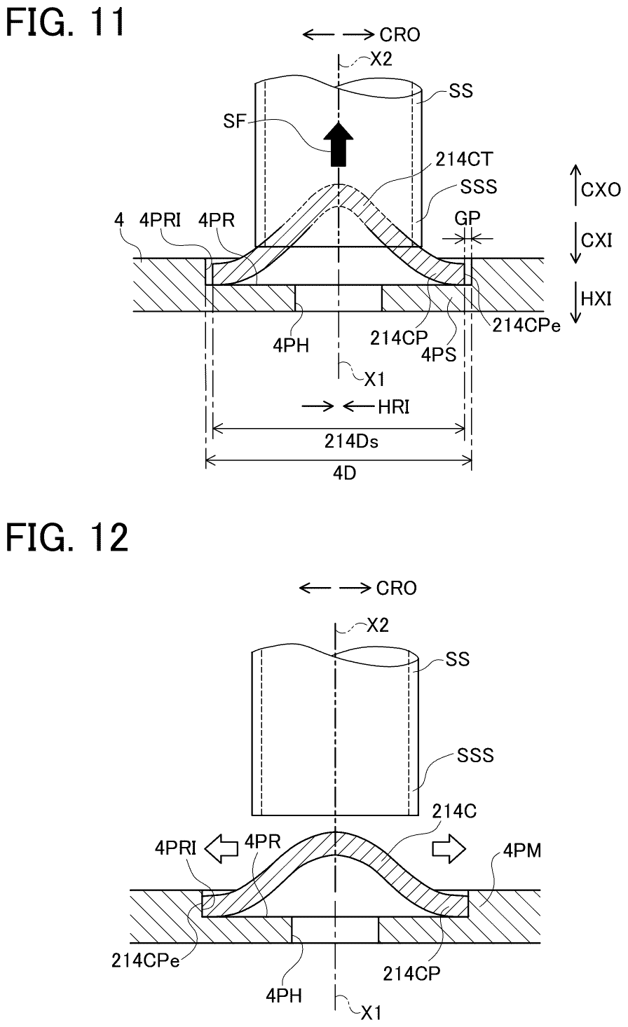

In a placing step S261B, subsequently, as shown in FIG. 11, the suction pipe SS is moved together with the unwelded cap 214C and places the unwelded cap 214C in a position where the outer circumferential edge portion 214CP is set in the circular recessed portion 4PR, that is, where the outer circumferential edge portion 214CP contacts the annular bottom portion 4PS over the entire circumference. Since the cap outer diameter 214Ds of the unwelded cap 214C in the radially contracted state is smaller than the recess inner diameter D4 of the circular recessed portion 4PR (214Ds<4D) as described above, the outer circumferential edge portion 214CP can be easily set in the circular recessed portion 4PR. In this state, a gap GP occurs between the outer peripheral end face 214CPe of the unwelded cap 214C and the inner peripheral surface 4PRI of the circular recessed portion 4PR.

In a subsequent releasing and contacting step S261C, the radially-contracting operation is released. Specifically, the sucking force SF of the suction pipe SS is eliminated, allowing the outer circumferential edge portion 214CP to be radially elastically expanded, thus bringing the outer circumferential edge portion 214CP into contact with the inner peripheral surface 4PRI of the circular recessed portion 4PR over the entire circumference. In other words, the outer peripheral end face 214CPe of the unwelded cap 214C is made to contact the inner peripheral surface 4PRI of the circular recessed portion 4PR over the entire circumference. At that time, the unwelded cap 214C is moved and positionally adjusted so that the cap axis X2 is aligned with the hole axis X1 of the circular recessed portion 4PR and the liquid inlet port 4PH. That is, the unwelded cap 214C is automatically aligned with the circular recessed portion 4PR and the liquid inlet port 4PH. In the second embodiment, the outer circumferential edge portion 214CP of the unwelded cap 214C elastically presses against the inner peripheral surface 4PRI of the circular recessed portion 4PR. This configuration can retain the unwelded cap 214C in the circular recessed portion 4PR even if the pressing force PF is not applied to the unwelded cap 214C as described in the first embodiment. After the radially-contracting operation is released, the suction pipe SS is moved.

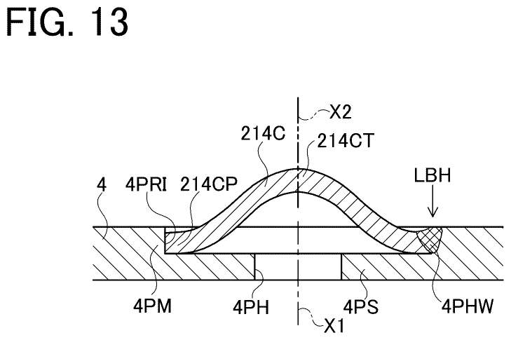

In a temporarily fixing step S262 prior to a full-circumference welding step S264, unlike the first embodiment, the outer circumferential edge portion 214CP of the unwelded cap 214C is welded to the recess surrounding portion 4PM at the appropriate number of scattered points without application of the pressing force PF as illustrated in FIG. 13. In the second embodiment, as in the first embodiment, using a laser beam LBH for temporary fixing, the outer circumferential edge portion 214CP and the recess surrounding portion 4PM are laser-welded together at three scattered points spaced at an angle of approximate 120° in the circumferential direction. Thus, the outer circumferential edge portion 214CP is temporarily fixed to the recess surrounding portion 4PM through three temporarily-joined portions 4PHW, while maintaining a contact state with the inner peripheral surface 4PRI of the circular recessed portion 4PR over the entire circumference. Consequently, the full-circumference welding step S264 can be performed while retaining the outer circumferential edge portion 214CP in contact with the inner peripheral surface 4PRI of the circular recessed portion 4PR over the entire circumference. This can further prevent the unwelded cap 214C from falling out of the circular recessed portion 4PR of the lid 4.

In the full-circumference welding step S264, furthermore, while the outer circumferential edge portion 214CP is in contact with the inner peripheral surface 4PRI of the circular recessed portion 4PR over the entire circumference, the outer circumferential edge portion 214CP is welded to the recess surrounding portion 4PM by the laser beam LB throughout the circumference. Thus, the liquid inlet port 4PH is hermetically sealed with the cap part 4PC (see FIG. 3). Moreover, the cap part 4PC in the second embodiment can prevent circumferential variations in welding conditions due to variations in the size of the gap GP, enabling uniform welding of the outer circumferential edge portion 214CP to the recess surrounding portion 4PM over the entire circumference, thus suppressing variations in the sealing strength of the cap part 4PC.

The foregoing first and second embodiments and modified embodiment are mere examples and give no limitation to the present disclosure. The present disclosure may be embodied in other specific forms without departing from the essential characteristics thereof.

For example, in the aforementioned embodiments, in the placing step S61A, S261B, the outer circumferential edge portion 14CP, 214CP is set in the circular recessed portion 4PR of the case 2 (see FIGS. 4 and 11). Accordingly, the top portion 14CT, 214CT protrudes outward from the lid outer surface 4OS.

However, for example, a lid with a deeper circular recessed portion than above or an unwelded cap of a lower profile than above may be adopted to set the entire unwelded cap inside the circular recessed portion, so that the cap top portion may not protrude outward from the lid outer surface.

In the foregoing first and second embodiments and modified embodiment, the temporarily fixing step S62, S262 is performed to temporarily fix the unwelded cap prior to the full-circumference welding step S64, S264, but the full-circumference welding step may be performed without temporary fixing of the unwelded cap. However, when the unwelded cap to be subjected to the radially-expanding operation is used as in the first embodiment, the full-circumference welding is conducted while continuously pressing the cap top portion without performing the pressure releasing step S63 of releasing the pressing operation.

In the foregoing modified embodiment, moreover, the inner peripheral surface 104PRI of the circular recessed portion 104PR provided in the lid 4 is designed with the truncated conical face shape whose diameter is larger toward the hole-axis-direction inside HXI, i.e., downward in FIG. 7. In addition, the unwelded cap 114C used therein is an unwelded cap 114C whose diameter can be expanded by the radially-expanding operation, in which the outer peripheral end face 114CPe has a shape whose diameter is larger toward the cap-axis-direction inside CXI, i.e., downward in FIG. 7.

Alternatively, an unwelded cap whose diameter can be contracted by the radially-contracting operation may be used as with the unwelded cap used in the second embodiment, in which the outer peripheral end face has a shape whose diameter is larger toward the cap-axis-direction inside CXI.

### REFERENCE SIGNS LIST

1, 101, 201 Battery (Power storage device)
2 Case (Metal case)
4 Lid (Side wall)
4OS Lid outer surface (Outer side wall surface)
4P, 104P Liquid inlet part
4PH, 104PH Liquid inlet port
4PR, 104PR Circular recess
4PRI, 104PRI Inner peripheral surface
D4 Recess inner diameter
4PM, 104PM Recess surrounding portion
4PRB, 104PRB Bottom surface
4PS, 104PS Annular bottom portion
4PC Cap part
4 PW Melt-solidification part
4PHW Temporarily-joined portion
14C, 114C, 214C Unwelded cap
D14, D214, 214Ds Cap outer diameter
14CT, 114CT, 214CT Top portion (Cap top portion)
14CP, 114CP, 214CP Outer peripheral edge portion (Cap outer circumferential edge portion)
214CI Inner portion (Cap inner portion)
14CPe, 114CPe, 214CPe Outer peripheral end face (Cap outer peripheral end face)
X1 Hole axis
HXI Hole-axis-direction inside (Thickness-direction inside)
HRI Hole-radial-direction inside
X2 Cap axis
CXI Cap-axis-direction inside
CXO Cap-axis-direction outside
CRI Cap-radial-direction inside
CRO Cap-radial-direction outside
PF Pressing force
SF Sucking force
S6, S260 Sealing step
S61, S261 Contacting step
S61A Placing step
S261A Sucking and radially-contracting step
S261B Placing step
S61B Diameter-expanding and contacting step
S261C Releasing and contacting step
S62, S262 Temporarily fixing step
S63 Pressure releasing step
S64, S264 Full-circumference welding step
LB Laser beam (Energy beam)

What is claimed is:

1. A method for producing a power storage device that comprises an electrode body, an electrolyte, and a metal case accommodating the electrode body and the electrolyte,
the metal case including:
a circular recessed portion provided in a side wall constituting the metal case, the circular recessed portion being recessed toward an inside in a thickness direction of the side wall,
the circular recessed portion being formed with a liquid inlet port in an annular bottom that forms a bottom surface of the circular recessed portion;
a recess surrounding portion that surrounds the circular recessed portion; and
a cap part welded to the recess surrounding portion to hermetically seal the liquid inlet port,
wherein the method comprises:
bringing an annular cap outer circumferential edge portion of an unwelded cap which will finally become the cap part, the cap outer circumferential edge portion being set in the circular recessed portion, into contact with an inner peripheral surface of the circular recessed portion of the metal case over an entire circumference; and
welding the cap outer circumferential edge portion to the recess surrounding portion over an entire circumference by a laser beam, while holding the cap outer circumferential edge portion in contact with the inner peripheral surface of the circular recessed portion over the entire circumference.

2. The method for producing a power storage device according to claim 1 further comprising,
after bringing the cap outer circumferential edge portion into contact with the inner peripheral surface of the circular recessed portion but before welding the cap outer circumferential edge portion to the recess surrounding portion,
temporarily fixing the cap outer circumferential edge portion to the circular recessed portion while holding the cap outer circumferential edge portion in contact with the inner peripheral surface of the circular recessed portion over the entire circumference.

3. The method for producing a power storage device according to claim 1,
wherein the unwelded cap is configured such that the cap outer circumferential edge portion is radially expanded by a radially-expanding operation, and
bringing the cap outer circumferential edge portion into contact with the inner peripheral surface of the circular recessed portion includes:
placing the unwelded cap so that at least the cap outer circumferential edge portion of the unwelded cap is set in the circular recessed portion of the metal case; and
radially expanding the cap outer circumferential edge portion by the radially-expanding operation to bring the cap outer circumferential edge portion into contact with the inner peripheral surface of the circular recessed portion over the entire circumference.

4. The method for producing a power storage device according to claim 2,
wherein the unwelded cap is configured such that the cap outer circumferential edge portion is radially expanded by a radially-expanding operation, and
bringing the cap outer circumferential edge portion into contact with the inner peripheral surface of the circular recessed portion includes:
placing the unwelded cap so that at least the cap outer circumferential edge portion of the unwelded cap is set in the circular recessed portion of the metal case; and
radially expanding the cap outer circumferential edge portion by the radially-expanding operation to bring the cap outer circumferential edge portion into contact with the inner peripheral surface of the circular recessed portion over the entire circumference.

5. The method for producing a power storage device according to claim 3,
wherein the unwelded cap is made of a metal plate and has a two-dimensional bell curved outer shape that is rotationally symmetric about a cap axis,
the unwelded cap includes:
a cap top portion; and
the cap outer circumferential edge portion located on an outside relative to the cap top portion in a cap radial direction, and
the radially-expanding operation is performed by:
pressing the cap top portion inward in a cap axis direction from the cap top portion toward the cap outer circumferential edge portion; and
radially expanding the cap outer circumferential edge portion outward in the cap radial direction.

6. The method for producing a power storage device according to claim 4,
wherein the unwelded cap is made of a metal plate and has a two-dimensional bell curved outer shape that is rotationally symmetric about a cap axis,
the unwelded cap includes:
a cap top portion; and
the cap outer circumferential edge portion located on an outside relative to the cap top portion in a cap radial direction, and
the radially-expanding operation is performed by:
pressing the cap top portion inward in a cap axis direction from the cap top portion toward the cap outer circumferential edge portion; and
radially expanding the cap outer circumferential edge portion outward in the cap radial direction.

7. The method for producing a power storage device according to claim 1,
wherein the unwelded cap is configured such that the cap outer circumferential edge portion is radially elastically contracted by a radially-contracting operation, and
bringing the cap outer circumferential edge portion into contact the inner peripheral surface of the circular recessed portion includes:
radially elastically contracting the cap outer circumferential edge portion by the radially-contracting operation;
placing the unwelded cap so that at least the radially contracted cap outer circumferential edge portion of the unwelded cap is set in the circular recessed portion; and
releasing the radially-contracting operation to radially expand the cap outer circumferential edge portion to bring the cap outer circumferential edge portion into contact with the inner peripheral surface of the circular recessed portion over the entire circumference.

8. The method for producing a power storage device according to claim 2,
wherein the unwelded cap is configured such that the cap outer circumferential edge portion is radially elastically contracted by a radially-contracting operation, and
bringing the cap outer circumferential edge portion into contact the inner peripheral surface of the circular recessed portion includes:
radially elastically contracting the cap outer circumferential edge portion by the radially-contracting operation;
placing the unwelded cap so that at least the radially contracted cap outer circumferential edge portion of the unwelded cap is set in the circular recessed portion; and
releasing the radially-contracting operation to radially expand the cap outer circumferential edge portion to bring the cap outer circumferential edge portion into contact with the inner peripheral surface of the circular recessed portion over the entire circumference.

9. The method for producing a power storage device according to claim 7,
wherein the unwelded cap is made of a metal plate and has a two-dimensional bell curved outer shape that is rotationally symmetric about a cap axis,
the unwelded cap includes:
the cap outer circumferential edge portion; and
a cap inner portion located on an inside relative to the cap outer circumferential edge portion in a cap radial direction perpendicular to an axis direction of the unwelded cap, and
the radially-contracting operation is performed by:
sucking the cap inner portion outward in the cap axis direction, from the cap outer circumferential edge portion toward the cap inner portion; and
radially elastically contracting the cap outer circumferential edge portion inward in the cap radial direction.

10. The method for producing a power storage device according to claim 8,
wherein the unwelded cap is made of a metal plate and has a two-dimensional bell curved outer shape that is rotationally symmetric about a cap axis,
the unwelded cap includes:
the cap outer circumferential edge portion; and
a cap inner portion located on an inside relative to the cap outer circumferential edge portion in a cap radial direction perpendicular to an axis direction of the unwelded cap, and
the radially-contracting operation is performed by:
sucking the cap inner portion outward in the cap axis direction, from the cap outer circumferential edge portion toward the cap inner portion; and
radially elastically contracting the cap outer circumferential edge portion inward in the cap radial direction.

11. The method for producing a power storage device according to claim 1,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

12. The method for producing a power storage device according to claim 2,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

13. The method for producing a power storage device according to claim 3,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

14. The method for producing a power storage device according to claim 4,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

15. The method for producing a power storage device according to claim 5,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

16. The method for producing a power storage device according to claim 6,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

17. The method for producing a power storage device according to claim 7,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

18. The method for producing a power storage device according to claim 8,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

19. The method for producing a power storage device according to claim 9,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.

20. The method for producing a power storage device according to claim 10,
wherein the inner peripheral surface of the circular recessed portion of the metal case has a shape whose diameter is larger toward the inside in the thickness direction of the side wall, and
the unwelded cap includes a cap outer peripheral end face having a shape whose diameter is larger toward the inside in the thickness direction of the side wall when the cap outer circumferential edge portion of the unwelded cap is set in the circular recessed portion.
